(19) United States
(12) Patent Application Publication
(10) Pub. No.: US 2004/0223524 A1
(43) Pub. Date: Nov. 11, 2004

(54) Mode-locked fiber laser

(75) Inventor: Michiharu Ohta, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA

(21) Appl. No.: 10/786,419

(22) Filed: Feb. 26, 2004

(30) Foreign Application Priority Data
Feb. 27, 2003 (JP) 2003-051175

(51) Int. Cl. H01S 3/098

(52) U.S. Cl. 372/18; 372/6

(57) ABSTRACT

To present a mode-locked fiber laser capable of exhibiting the mode locking function of the saturable absorber sufficiently without requiring adjustment of optical axis. That is, by enveloping the end face at one end side of an EDF 11 (including the end face of a waveguide 21) by a saturable absorber 15 affixed in a direction of one end of the EDF 11 to a gold mirror 16, a beam of large density can be applied to the saturable absorber 15 without using lens requiring adjustment of optical axis, and further almost all of the beam passing through the saturable absorber 15 can be returned to the waveguide 21 of the EDF 11.

### CROSS REFERENCE TO RELATED APPLICATIONS

This application is based on and claims priority under 35 U.S.C. §119 with respect to Japanese Patent Application 2003-051175, filed on Feb. 27, 2003, the entire content of which is incorporated herein by reference.

### FIELD OF THE INVENTION

The present invention relates to a mode-locked fiber laser using an amplifying fiber as laser medium.

### BACKGROUND OF THE INVENTION

Description of the Prior Art Hitherto, as shown in FIG. 11, a mode-locked fiber laser 100 is composed of, for example, a pair of reflectors 106, 111, a single-mode amplifying fiber doping Er (erbium) as laser medium (EDF) 101, a laser diode 119 as pumping source, and a saturable absorber 105 for starting mode-lock. The saturable absorber 105 is enough if its thickness is less than 1 micron, and hence it is evaporated to the reflector 106 which is a gold mirror. In the mode-locked fiber laser 100 of the prior art, when pump light from the laser diode 119 is supplied into the EDF 101 by way of wavelength division multiplexing coupler (WDM) 118, it is multiplexed to become standing wave while commuting between the pair of reflectors 106 and 111. At this time, the saturable absorber 105 is a starter for producing mode-locked standing waves. In the saturable absorber 105, to emphasize the function of decreasing the absorption for strong light and increasing the absorption for weak light, it is required to make light of large density incident. Accordingly, in the mode-locked fiber laser 100 of the prior art, pulse light taken out to the space from the EDF 101 is collimated by the lens 102, and the pulse light focused by the lens 104 is emitted to the saturable absorber 105. Further, in the mode-locked fiber laser 100 of the prior art, to stabilize mode locking, for example, a Faraday rotator is used as reflector 111, and a Faraday rotator 103 is disposed between the lenses 102 and 104 (see, for example patent reference 1). [Patent reference 1] Japanese Unexamined Patent Publication No. 8-51246. Between the WDM 118 and reflector 111, by disposing a single-mode fiber 117, a lens 116, a quarter wavelength plate 115, a half wavelength plate 114, a polarizing beam splitter 113, and a lens 112, laser output is obtained by way of the polarizing beam splitter 113.

However, to reciprocate the pulse light taken out to the space from the EDF 101 between the pair of reflectors 106 and 111, after reflecting by the reflector 106, the light must be brought back to the EDF 101 by way of the lenses 104, 102, but, in this case, since the diameter of the waveguide of the EDF 101 is very small, about 10 microns, the holding parts of the lenses 104, 102 may be moved by thermal or mechanical fluctuations, and if the optical axis is deviated slightly, the quantity of light of laser output varies. The present invention is devised in the light of the above problems, and it is hence an object thereof to present a mode-locked fiber laser capable of sufficiently exhibiting the mode locking function of the saturable absorber without requiring adjustment of optical axis.

### SUMMARY OF THE INVENTION

To solve these problems, it is the first aspect of the invention to present a mode-locked fiber laser comprising a pair of reflectors, the amplifying fiber disposed as laser medium between the reflectors and having a waveguide, and a saturable absorber affixed in a direction of one end of the amplifying fiber in one of the reflectors, in which at least the end face of the waveguide at one end of the amplifying fiber is enveloped with the saturable absorber. In the mode-locked fiber laser of the present invention having such features, at least the end face of the waveguide at one end of the amplifying fiber is concealed by the saturable absorber. Herein, the diameter of the waveguide of the amplifying fiber is about 10 microns, for example, in single mode, and the beam in the process of propagation through the waveguide of the amplifying fiber or the beam right after being emitted from the waveguide of the amplifying fiber is very small in diameter, having a light density nearly same as when focusing by the lens. Therefore, a beam of large density can be applied to the saturable absorber concealing the end face of the waveguide at one end side of the amplifying fiber.

The beam passing through the saturable absorber is reflected by one of the reflectors affixed to the saturable absorber, passes again through the saturable absorber, and returns to the waveguide of the amplifying fiber. In this case, the saturable absorber is enough at a thickness of, for example, 1 micron or less in order to exhibit the mode locking function sufficiently. Therefore, the emitted beam from the waveguide of the amplifying fiber commutes and passes through the very thin saturable absorber, and hence enters the waveguide of the amplifying fiber without spreading practically. Therefore, almost all of the beam passing through the saturable absorber returns to the waveguide of the amplifying fiber. Herein, being “enveloped” means at least concealing of end face of waveguide at one end side of the amplifying fiber by the saturable absorber as mentioned before. For this purpose, the saturable absorber may mechanically contact with the end face of the waveguide at one end side of the amplifying fiber, or the saturable absorber may be evaporated to the end face of the waveguide at one end side of the amplifying fiber. Or, only the end face of the waveguide at one end side of the amplifying fiber may be concealed by the saturable absorber, or the end face of one end side of the amplifying fiber (including the end face of the waveguide) may be concealed by the saturable absorber. That is, in the mode-locked fiber laser of the present invention, by enveloping the end face of the waveguide at one end side of the amplifying fiber, at least, with the saturable absorber affixed in a direction of one end of the amplifying fiber in one of the reflectors, a beam of large density can be applied to the saturable absorber without using lens requiring adjustment of optical axis, and further almost all of the beam passing through the saturable absorber can be returned to the waveguide of the amplifying fiber, and therefore the mode locking function of the saturable absorber can be exhibited sufficiently without requiring adjustment of optical axis. It is the second aspect of the invention to present a mode-locked fiber laser comprising a pair of reflectors, an amplifying fiber disposed as laser medium between the reflectors and having a waveguide, and a saturable absorber disposed between one of the reflectors and one end of the amplifying fiber, in which at least the end face of the waveguide at one end side of the amplifying fiber is enveloped with the saturable absorber, and one of the reflectors is formed in a shape having the focusing point matched on the end face of the waveguide at one end side of the amplifying fiber, incorporates the saturable absorber, and is fixed at one end side of the amplifying fiber. In the mode-locked fiber laser of the present invention having such features, at least the end face of the waveguide at one end side of the amplifying fiber is concealed by the saturable absorber. Herein, the diameter of the waveguide of the amplifying fiber is about 10 microns, for example, in single mode, and the beam in the process of propagation through the waveguide of the amplifying fiber or the beam right after being emitted from the waveguide of the amplifying fiber is very small in diameter, having a light density nearly same as when focusing by the lens. Therefore, a beam of large density can be applied to the saturable absorber concealing the end face of the waveguide at one end side of the amplifying fiber. The beam passing through the saturable absorber is reflected by one of the reflectors fixed at one end side of the amplifying fiber, passes again through the saturable absorber, and returns to the waveguide of the amplifying fiber. In this case, one of the reflectors is formed in a shape having the focusing point matched on the end face of the waveguide at one end side of the amplifying fiber. Therefore, the emitted beam from the waveguide of the amplifying fiber is reflected by one of the reflectors, and advances to the focusing point on the end face of the waveguide at one end side of the amplifying fiber. Therefore, all of the beam passing through the saturable absorber can return to the waveguide of the amplifying fiber.

Incidentally, the thickness of the saturable absorber may be enough at, for example, less than 1 micron for sufficiently exhibiting the mode locking function, as far as the light density is enough for exhibiting the mode locking function in the saturable absorber and a sufficient quantity of light returns to the waveguide, the focusing point in the shape of one reflector may be somewhat deviated to the saturable absorber side from the end face of the waveguide at one end side of the amplifier fiber, or to its opposite side (waveguide side). In order that one of the reflectors be formed in a shape having the focusing point matched on the end face of the waveguide at one end side of the amplifying fiber, it is enough to use the reflector of which plane of reflection has a concave shape or spherical shape. As mentioned above, being “enveloped” means at least concealing of end face of waveguide at one end side of the amplifying fiber by the saturable absorber. For this purpose, the saturable absorber may mechanically contact with the end face of the waveguide at one end side of the amplifying fiber, or the saturable absorber may be evaporated to the end face of the waveguide at one end side of the amplifying fiber. Or, only the end face of the waveguide at one end side of the amplifying fiber may be concealed by the saturable absorber, or the end face of one end side of the amplifying fiber (including the end face of the waveguide) may be concealed by the saturable absorber.

That is, in the mode-locked fiber laser of the present invention, by enveloping the end face of the waveguide at one end side of the amplifying fiber, at least, by the saturable absorber existing in one of the reflectors fixed at one end side of the amplifying fiber, a beam of large density can be applied to the saturable absorber without using lens requiring adjustment of optical axis, and further since one of the reflectors is formed in a shape having the focusing point matched on the end face of the waveguide at one end side of the amplifying fiber, all of the beam passing through the saturable absorber can be returned to the waveguide of the amplifying fiber without using lens requiring adjustment of optical axis, and therefore the mode locking function of the saturable absorber can be exhibited sufficiently without requiring adjustment of optical axis. The third aspect of the invention relates to the mode-locked fiber laser of the first or second aspect, which further comprises an in-line fiber Faraday rotator integrated with the amplifying fiber. That is, in the mode-locked fiber laser of the present invention, the mode locking function of the saturable absorber can be exhibited sufficiently without using lens requiring adjustment of optical axis, and the space for depositing the lens is saved, and the advantage of the fiber laser is enhanced by saving the space, and moreover when the mode-locked fiber laser of the present invention further comprises an in-line fiber Faraday rotator integrated with the amplifying fiber, mode locking stabilized, and, for example, the Faraday rotator (its installing space) for stabilizing mode locking can be saved, so that the advantage of fiber laser is further enhanced by saving the space.

### BRIEF DESCRIPTION OF THE DRAWING FIGURES

FIG. 1 is an outline diagram of part of mode-locked fiber laser in a preferred embodiment of the invention;

FIG. 2 is a diagram showing a modified example of mode-locked fiber laser in the preferred embodiment of the invention;

FIG. 3 is a diagram showing a modified example of mode-locked fiber laser in the preferred embodiment of the invention;

FIG. 4 is a diagram showing a modified example of mode-locked fiber laser in the preferred embodiment of the invention;

FIG. 5 is a diagram showing a modified example of mode-locked fiber laser in the preferred embodiment of the invention;

FIG. 6 is a diagram showing a modified example of mode-locked fiber laser in the preferred embodiment of the invention;

FIG. 7 is a diagram showing a modified example of mode-locked fiber laser in the preferred embodiment of the invention;

FIG. 8 is a diagram showing wavelength component of output laser of mode-locked fiber laser in the preferred embodiment of the invention;

FIG. 9 is a diagram showing oscillation mode of mode-locked fiber laser in the preferred embodiment of the invention;

FIG. 10 is a diagram showing improvement points of mode-locked fiber laser shown in FIG. 11, relating to the mode-locked fiber laser in the preferred embodiment of the invention; and

FIG. 11 is an outline diagram of mode-locked fiber laser in prior art.

### DETAILED DESCRIPTION OF THE INVENTION

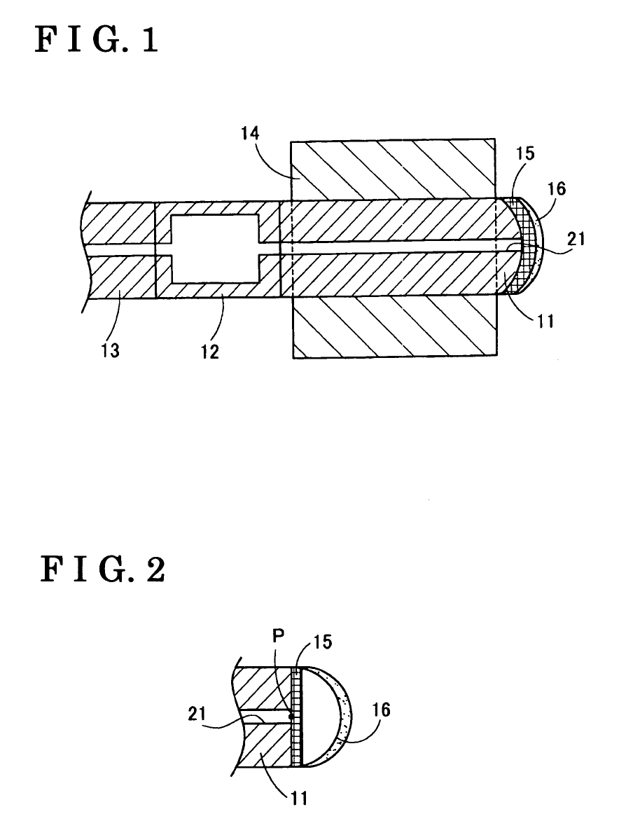

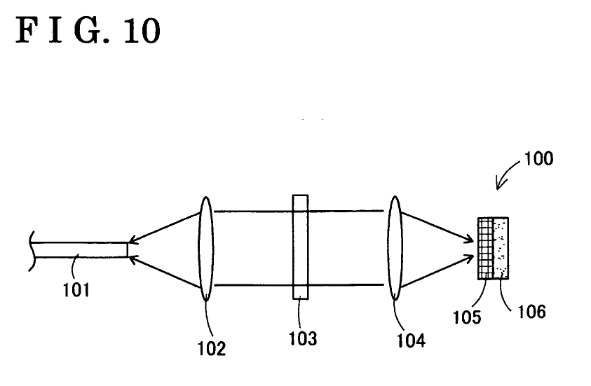

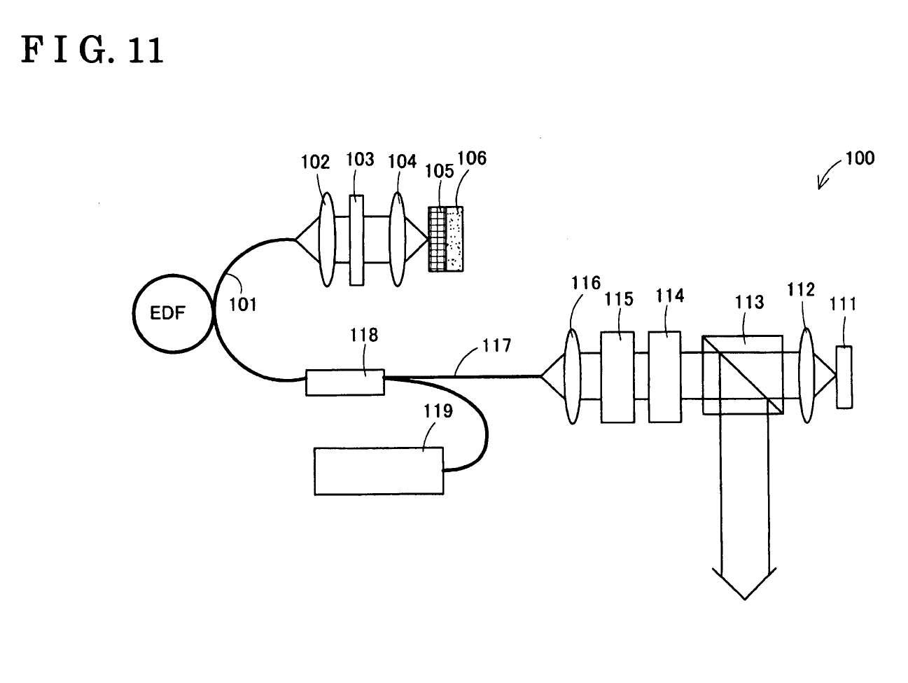

Referring now to the drawings, a preferred embodiment of the present invention is described in detail below. The mode-locked fiber laser in the preferred embodiment is similar to the mode-locked fiber laser 100 (see FIG. 11) of the prior art, except that components from EDF 101 to reflector 106 shown in FIG. 10 are modified. Modified points are described specifically below. In the mode-locked fiber laser of the preferred embodiment, as shown in FIG. 1, a saturable absorber 15 (thickness of 1 micron or less) with one side coated with gold is set in contact with an end face at one end side of a single-mode EDF 11 fitted in a PC ferrule 14. Since the entire surface of the end face at one end side of the single-mode EDF 11 is covered with the saturable absorber 15, the end face of a waveguide 21 at one end side of the EDF 11 is also covered with the saturable absorber 15. The gold coated portion at one side of the saturable absorber 15 is a gold mirror 16, which corresponds to the reflector 106 in the prior art (see FIG. 10, FIG. 11). Instead of the saturable absorber 15 contacting with the end face at one end side of the EDF 11, the saturable absorber 15 having the gold mirror 16 already affixed may be pressed mechanically against the end face at one end side of the EDF 11, or at the end face at one end side of the EDF 11, the saturable absorber 15 and gold mirror 16 may be vacuum-evaporated sequentially. In the mode-locked fiber laser of the preferred embodiment, as shown in FIG. 1, one end side of an in-line fiber Faraday rotator 12 is fused to the other end side of the EDF 11 fitted in the PC ferrule 14, and one end side of a single-mode EDF 13 is fused to the other end side of the in-line fiber Faraday rotator 12. The other end side of the EDF 13 is connected to a WDM 118 in FIG. 11, and all other structural points are same as in the mode-locked fiber laser 100 (FIG. 11) mentioned in the prior art. In particular, the reflector 111 in FIG. 11 is the Faraday rotator.

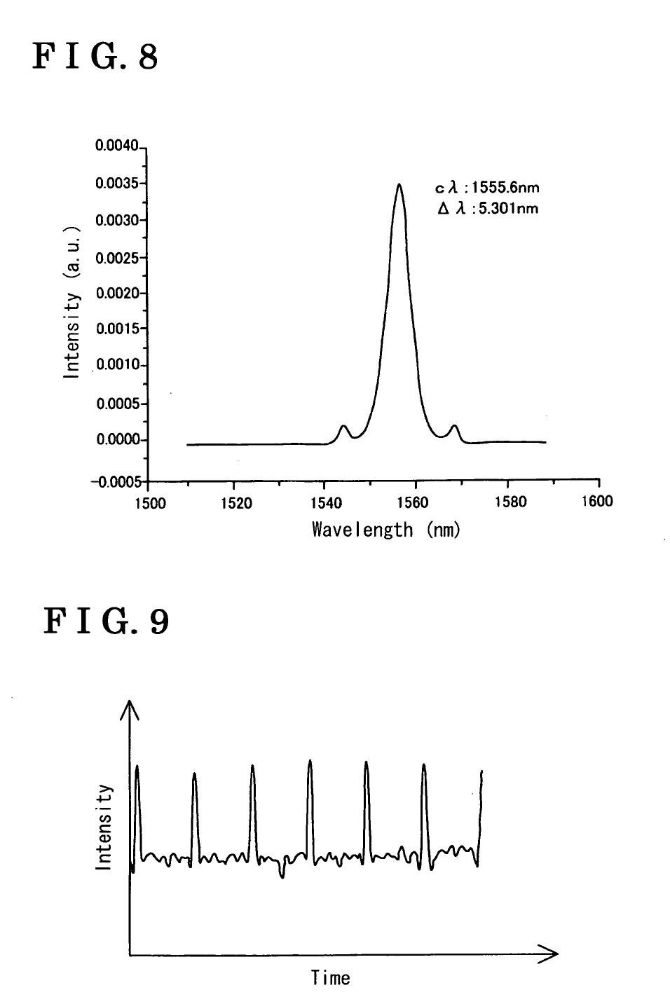

In the mode-locked fiber laser of the preferred embodiment, the waveform component of output laser is shown in FIG. 8, and the oscillation mode is shown in FIG. 9. It is known from FIG. 8 and FIG. 9 that the mode-locked laser output is given stably in the mode-locked fiber laser of the preferred embodiment.

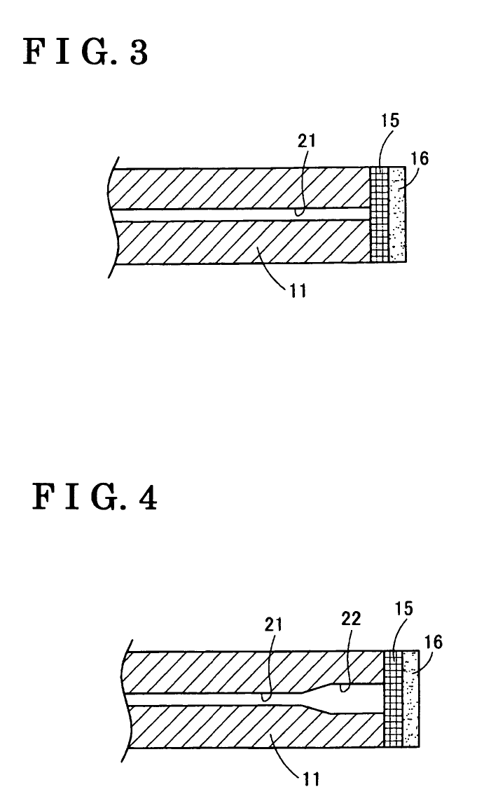

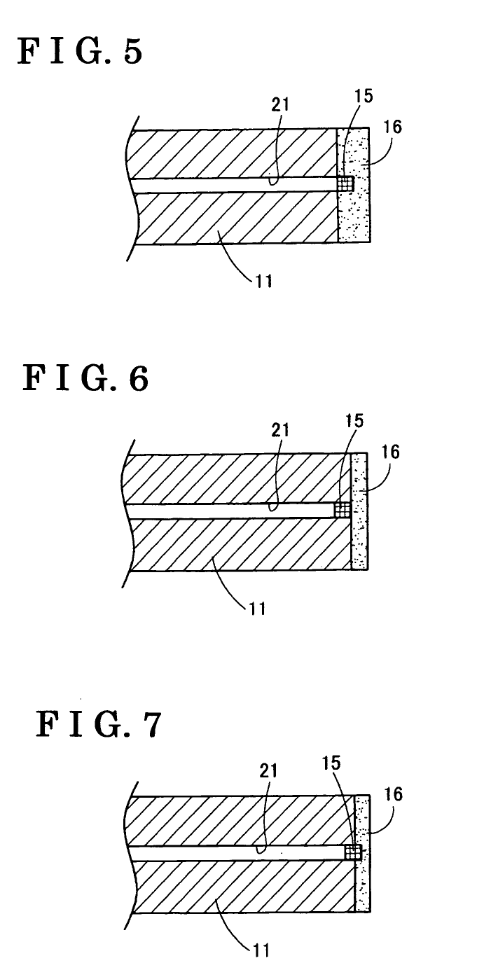

Thus, in the mode-locked fiber laser of the preferred embodiment shown in FIG. 1, the end face (including the end face of the waveguide 21) at one end side of the EDF 11 is concealed by the saturable absorber 15. The diameter of the waveguide 21 of the EDF 11 is about 10 microns, and the beam during propagation through the waveguide 21 of the EDF 11 or the beam right after being emitted from the waveguide 21 of the EDF 11 is very small in diameter, having a light density nearly same as when focusing by the lens. Therefore, a beam of large density can be applied to the saturable absorber 15 concealing the end face of the waveguide 21 at one end side of the EDF 11. The beam passing through the saturable absorber 15 is reflected by the gold mirror 16 gold-coated to the saturable absorber 15, passes again through the saturable absorber 15, and returns to the waveguide 21 of the EDF 11. In this case, the saturable absorber 15 is designed to exhibit the mode locking function sufficiently, and its thickness is 1 micron or less. Therefore, the emitted beam from the waveguide 21 of the EDF 11 commutes and passes through the very thin saturable absorber 15, and hence enters the waveguide 21 of the EDF 11 without spreading practically. Therefore, almost all of the beam passing through the saturable absorber 15 returns to the waveguide 21 of the EDF 11. That is, in the mode-locked fiber laser of the preferred embodiment shown in FIG. 1, by enveloping the end face at one end side of the EDF 11 (including the end face of the waveguide 21) by the saturable absorber 15 affixed in a direction of one end of the EDF 11 to the gold mirror 16, a beam of large density can be applied to the saturable absorber 15 without using lens (lens 102 or 104 in FIG. 10, FIG. 11) requiring adjustment of optical axis, and further almost all of the beam passing through the saturable absorber 15 can be returned to the waveguide 21 of the EDF 11, and therefore the mode locking function of the saturable absorber 15 can be exhibited sufficiently without requiring adjustment of optical axis. Further, in the mode-locked fiber laser of the preferred embodiment shown in FIG. 1, since the mode locking function of the saturable absorber 15 can be exhibited sufficiently without using lens (lens 102 or 104 in FIG. 10, FIG. 11) requiring adjustment of optical axis, the installation space for such lenses (lens 102 or 104 in FIG. 10, FIG. 11) is saved, and the advantage of the fiber laser is enhanced by saving the space. Moreover, in the mode-locked fiber laser of the preferred embodiment, the in-line fiber Faraday rotator 12 integrated with the EDF 11 is provided, and mode locking stabilized, and the Faraday rotator 103 (see FIG. 11) in the prior art for stabilizing mode locking can be saved, that is, its installation space is saved, so that the advantage of fiber laser is further enhanced by saving the space. Also, in the mode-locked fiber laser of the preferred embodiment shown in FIG. 1, the end face at one end side of the EDF 11 enveloped with the saturable absorber 15 is convex, but it may be flat as shown in FIG. 3. Further, as shown in FIG. 4, a core expanded portion 22 may be provided in the waveguide 21 at one end side of the EDF 11 enveloped with the saturable absorber 15. In FIG. 4, the whole part of the end face at one end side of the EDF 11 is enveloped with the saturable absorber 15, but only the end face of the waveguide 21 at one end side of the EDF 11 may be enveloped with the saturable absorber 15. For example, as shown in FIG. 5, only the end face of the waveguide 21 at one end side of the EDF 11 may be covered with the saturable absorber 15, and the end face at one end side of the EDF 11 and the saturable absorber 15 may be covered with the gold mirror 16. Or, as shown in FIG. 6, a part of the waveguide 21 at one end side of the EDF 11 may be formed as the saturable absorber 15, and the end face at one end side of the EDF 11 and the saturable absorber 15 may be covered with the gold mirror 16. Further, as shown in FIG. 7, a part of the waveguide 21 at one end side of the EDF 11 may be formed as the saturable absorber 15, and the saturable absorber 15 may be projected from one end side of the EDF 11, and the end face at one end side of the EDF 11 and the saturable absorber 15 may be covered with the gold mirror 16. In FIG. 5, FIG. 6, and FIG. 7, only the exposed portion of the saturable absorber 15 may be covered with the gold mirror 16. In FIG. 6, a part of the waveguide 21 at one end side of the EDF 11 may be formed as a hollow space, and it may be filled with powder of saturable absorber 15 (for example, carbon nano tube). In the mode-locked fiber laser of the preferred embodiment in FIG. 1, the gold mirror 16 gold-coated to the saturable absorber 15 is concave, and by optimizing the curvature of the concave gold mirror 16, all of the beam passing through the saturable absorber 15 may be returned to the waveguide 21 of the EDF 11. For example, FIG. 2 shows a flat shape of the end face at one end side of the EDF 11 enveloped with the saturable absorber 15, but by fixing a bulky gold mirror 16 to one end side of the EDF 11, when the shape of the gold mirror 16 is formed in a semicircular shape having the center in the central point on the end face of the waveguide 21 at one end side of the EDF 11, the central point on the end face of the waveguide 21 at one end side of the EDF 11 is formed as the focusing point P of the gold mirror 16, so that all of the beam passing through the saturable absorber 15 can be returned to the waveguide 21 of the EDF 11. Thus, in the mode-locked fiber laser of the preferred embodiment in FIG. 2, the end face at one end side of the EDF 11 (including the end face of the waveguide 21) is concealed by the saturable absorber 15. Herein, the diameter of the waveguide 21 of the EDF 11 is about 10 microns, and the beam in the process of propagation through the waveguide 21 of the EDF 11 or the beam right after being emitted from the waveguide 21 of the EDF 11 is very small in diameter, having a light density nearly same as when focusing by the lens. Therefore, a beam of large density can be applied to the saturable absorber 15 concealing the end face of the waveguide 21 at one end side of the EDF 11. The beam passing through the saturable absorber 15 is reflected by the gold mirror 16 fixed at one end side of the EDF 11, passes again through the saturable absorber 15, and returns to the waveguide 21 of the EDF 11. In this case, the gold mirror 16 is formed in a semicircular shape having the focusing point P matched in the center on the end face of the waveguide 21 at one end side of the EDF 11. Therefore, the emitted beam from the waveguide 21 of the EDF 11 is reflected by the gold mirror 16, and advances to the focusing point P on the end face of the waveguide 21 at one end side of the EDF 11. Therefore, all of the beam passing through the saturable absorber 15 can return to the waveguide 21 of the EDF 11. The focusing point P in the semicircular shape of the gold mirror 16 may be located anywhere on the end face of the waveguide 21 at one end side of the EDF 11, and considering that the required thickness of the saturable absorber 15 is only 1 micron or less for sufficient exhibition of the mode locking function, as far as having a light density enough to exhibit the mode locking function in the saturable absorber 15 and enough quantity of light can return to the waveguide 21 of the EDF 11, it may be slightly deviated to the saturable absorber 15 side or opposite side (the side of the waveguide 21) from the end face of the waveguide 21 at one end side of the EDF 11. The shape of the gold mirror 16 is not limited to the semicircular shape. That is, in the mode-locked fiber laser of the preferred embodiment in FIG. 2, by enveloping the end face at one end side of the EDF 11 (including the end face of the waveguide 21) by the saturable absorber 15 existing in the gold mirror 16 fixed at one end side of the EDF 11, a beam of large density can be applied to the saturable absorber 15 without using lens (lens 102 or 104 in FIG. 10, FIG. 11) requiring adjustment of optical axis, and further since the gold mirror 16 is formed in a shape having the focusing point P matched on the end face of the waveguide 21 at one end side of the EDF 11, all of the beam passing through the saturable absorber 15 can be returned to the waveguide 21 of the EDF 11 without using lens (lens 102 or 104 in FIG. 10, FIG. 11) requiring adjustment of optical axis, and therefore the mode locking function of the saturable absorber 15 can be exhibited sufficiently without requiring adjustment of optical axis. In FIG. 2, all part of the end face at one end side of the EDF 11 is enveloped with the saturable absorber 15, but only the end face of the waveguide 21 at one end side of the EDF 11 may be enveloped with the saturable absorber 15. The present invention is not limited to the illustrate embodiments alone, but may be changed and modified within a scope not departing from the true spirit thereof.

For example, in the mode-locked fiber laser of the preferred embodiment, the EDF 11 may be a mere fiber of single mode. The PC ferrule 14 is used for the sake of convenience of handling, and it may not be always required. As described herein, according to the mode-locked fiber laser of the present invention, by enveloping the end face of the waveguide at one end side of the amplifying fiber, at least, by the saturable absorber affixed in a direction of one end of the amplifying fiber to one of the reflectors, a beam of large density can be applied to the saturable absorber without using lens requiring adjustment of optical axis, and further almost all of the beam passing through the saturable absorber can be returned to the waveguide of the amplifying fiber, and therefore the mode locking function of the saturable absorber can be exhibited sufficiently without requiring adjustment of optical axis. Further, in the mode-locked fiber laser of the present invention, by enveloping the end face of the waveguide at one end side of the amplifying fiber, at least, by the saturable absorber existing in one of the reflectors fixed at one end side of the amplifying fiber, a beam of large density can be applied to the saturable absorber without using lens requiring adjustment of optical axis, and further since one of the reflectors is formed in a shape having the focusing point matched on the end face of the waveguide at one end side of the amplifying fiber, all of the beam passing through the saturable absorber can be returned to the waveguide of the amplifying fiber without using lens requiring adjustment of optical axis, and therefore the mode locking function of the saturable absorber can be exhibited sufficiently without requiring adjustment of optical axis. Still more, in the mode-locked fiber laser of the present invention, the mode locking function of the saturable absorber can be exhibited sufficiently without using lens requiring adjustment of optical axis, and the lens space is saved, and the advantage of the fiber laser is enhanced by saving the space, and moreover when the mode-locked fiber laser of the present invention further comprises an in-line fiber Faraday rotator integrated with the amplifying fiber, mode locking stabilized, and, for example, the Faraday rotator (its installing space) for stabilizing mode locking can be saved, so that the advantage of fiber laser is further enhanced by saving the space.

What is claimed is:

1. A mode-locked fiber laser comprising a pair of reflectors, an amplifying fiber disposed as laser medium between said reflectors and having a waveguide, and a saturable absorber affixed in a direction of one end of said amplifying fiber to one of the reflectors, wherein at least the end face of the waveguide at one end of said amplifying fiber is enveloped with said saturable absorber.

2. A mode-locked fiber laser comprising a pair of reflectors, an amplifying fiber disposed as laser medium between said reflectors and having a waveguide, and a saturable absorber disposed between one of said reflectors and one end of said amplifying fiber, wherein at least the end face of the waveguide at one end of said amplifying fiber is enveloped with said saturable absorber, and one of said reflectors is formed in a shape having the focusing point matched on the end face of the waveguide at one end side of said amplifying fiber, incorporates said saturable absorber, and is fixed at one end side of said amplifying fiber.

3. The mode-locked fiber laser of claim 2, further comprising: an in-line fiber Faraday rotator integrated with said amplifying fiber.
